(19) United States
(12) Patent Application Publication
(10) Pub. No.: US 2026/0145484 A1
(43) Pub. Date: May 28, 2026

(54) AUTOMOTIVE HOT GAS HEAT PUMP SYSTEM AND A CONTROLLING METHOD THEREOF

(71) Applicants: HYUNDAI MOTOR COMPANY, Seoul (KR); KIA CORPORATION, Seoul (KR)

(72) Inventors: Jungmo Yu, Hwaseong-si (KR); Jeawan Kim, Hwaseong-si (KR)

(73) Assignees: HYUNDAI MOTOR COMPANY, Seoul (KR); KIA CORPORATION, Seoul (KR)

(21) Appl. No.: 19/249,645

(22) Filed: Jun. 25, 2025

(30) Foreign Application Priority Data
Nov. 22, 2024 (KR) 10-2024-0168357

(51) Int. Cl. B60H 1/00

(52) U.S. Cl. CPC B60H 1/00899; B60H 1/00485; B60H 1/00885

(57) ABSTRACT

An automotive hot gas heat pump system includes a sensor unit; a hot gas heat pump device; an air conditioning control unit; and a hot gas mode heat source generator. The hot gas heat pump device includes a hot gas bypass valve configured to open and close a path through which a gaseous refrigerant branched and supplied from a compressor re-enters the compressor. The air conditioning control unit is configured to control the hot gas heat pump device to be operated in a heat pump mode or a hot gas mode based on a heat absorption amount and generate an inefficient PE motor operation start signal when the hot gas heat pump device is operated in the hot gas mode. The PE heat source generator is configured to generate the PE heat source by driving a driving motor in an inefficient mode based on the PE motor operation start signal.

### CROSS-REFERENCE TO RELATED APPLICATION

This application claims priority to and the benefit of Korean Patent Application No. 10-2024-0168357, filed at the Korean Intellectual Property Office on Nov. 22, 2024, the entire contents of which are incorporated herein by reference.

### TECHNICAL FIELD

The present disclosure relates to an automotive hot gas heat pump system and a controlling method thereof. More particularly, the present disclosure relates to an automotive hot gas heat pump system for efficiently operating in a hot gas mode and relates to a controlling method thereof.

### BACKGROUND

An automobile may generally include an air conditioning system (hereinafter also referred to as an “air conditioning device”) to regulate an indoor air temperature. This automotive air conditioning device may generate warm air to maintain an automobile interior warm in winter and may cold air to maintain the interior cool in summer.

In a general automotive air conditioning device, a compressor, a condenser, an expansion valve, and an evaporator are sequentially connected with each other along a refrigerant pipe, and a refrigerant may be circulated when the compressor is driven by engine power. The automotive air conditioning device may convert a refrigerant gas, compressed to a high temperature and a high pressure by the compressor, into a liquid state by exchanging heat with surrounding air when the refrigerant gas passes through the condenser. The liquefied refrigerant may be changed into a low-temperature gas as the refrigerant passes through the expansion valve. In addition, the vaporized low-temperature refrigerant may be cooled or heated while exchanging heat with the surrounding air when the refrigerant passes through the evaporator. The cooled or heated air may be discharged into the automobile interior by a blower. The low-temperature gaseous refrigerant that passed through the evaporator may return to the compressor and be repeatedly circulated through a process of being compressed to the high temperature and the high pressure.

In recent years, an electric automobile that uses electric energy as a power source has been released, and the air conditioning device (heating device) installed in the electric automobile may heat the automobile interior through an electric heater that heats water or air by using power supplied from a battery. Thus, power performance of the electric automobile may be significantly reduced.

For example, a heating device for the electric automobile may use a heat pump system in addition to the electric heater. The heat pump system may be a combined cooling and heating system that operates by reversibly applying a compression-condensation-expansion-evaporation cycle of the refrigerant.

FIG. 1 is a diagram showing a conventional heating system used in an electric automobile.

Referring to FIG. 1, the conventional heating system in an electric automobile may include a heat pump system 20 and a positive temperature coefficient (PTC) electric heater 10, combined with each other.

The heat pump system 20 is a heating device that absorbs heat from a low-temperature heat source 30 and generates heat by using a high-temperature heat source rather than producing heat on its own. The heat source 30 may include a power electronics (PE) heat source 31 generated by a power electronics module (hereinafter, also referred to as the “PE module”), an exterior heat source 32, and a heat source 33 generated by a battery (BATT). A power electronics (PE) module is a component designed to combine a drive/driving system of the electric automobile into small parts. The drive/driving system replaces functions of the engine and transmission in a conventional internal combustion engine automobile. The PE module refers to a drive motor, a reducer, an inverter for power conversion, or the like.

The heat pump system 20 may have excellent heating performance and efficiency when heat absorption source is sufficient. The heat pump system 20 may have lower heating performance and efficiency when the heat absorption source is insufficient. Accordingly, if the heat absorption source is insufficient, it is difficult to respond to a heating load by using only the heat pump system 20, and the relatively low-efficiency PTC electric heater 10 may be used to respond to the load.

However, this electric automobile heating method requires the addition of the separate PTC electric heater 10 in addition to the heat pump system 20. This may result in an additional cost and an increased volume.

Meanwhile, the battery in the electric automobile may be mainly made of a lithium-ion battery having excellent energy density at room temperature and excellent performance when considering charge and discharge cycles. However, the lithium-ion battery may have reduced capacity, increased resistance, and decreased efficiency at a low temperature due to a property of an electrolyte included in the lithium-ion battery. In particular, when the lithium-ion battery is charged at the low temperature, lithium ions may be unevenly deposited on a surface of a negative electrode, and thus its lifespan is shortened. This problem requires a heating device capable of rapidly raising a temperature of the lithium-ion battery from a low temperature state to a high temperature state where the battery has high efficiency.

FIG. 2 is a schematic diagram of a conventional battery heating device used in an electric automobile. A conventional battery heating method uses a method of directly heating a battery 50 by adding a PTC electric heater 42 or circulating a coolant supplied to the battery 50 by heating the coolant through an electronic water pump 41 (also referred to as “EWP”). However, this conventional battery heating method requires the addition of the separate PTC electric heater 42. This may result in the additional cost and the increased volume. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure aims to provide an automotive hot gas heat pump system and a controlling method thereof capable of heating an electric automobile without a positive temperature coefficient (PTC) electric heater even when a heat absorption source is insufficient.

In addition, the present disclosure aims to provide an automotive hot gas heat pump system and a controlling method thereof capable of heating a battery without any PTC electric heater.

According to an embodiment, an automotive hot gas heat pump system includes a sensor unit configured to measure a temperature of at least one of the exterior heat source, power electronics (PE) heat source, or battery heat source of an automobile. The system further includes a hot gas heat pump device including a compressor. The hot gas heat pump device further includes a condenser configured to release heat by condensing a high-temperature and high-pressure gaseous refrigerant supplied from the compressor. The hot gas heat pump device further includes a hot gas bypass valve configured to open and close a path through which the high-temperature and high-pressure gaseous refrigerant, branched from the compressor, re-enters the compressor. The hot gas bypass valve is configured to be operated in a heat pump mode or a hot gas mode based on opening or closing operation of the hot gas bypass valve. The system further includes an air conditioning control unit configured to control the hot gas heat pump device to be operated in the heat pump mode or the hot gas mode based on a heat absorption amount. The heat absorption amount is determined based on the temperature measured by the sensor unit and a required heating load. The air conditioning control unit is configured to control an inefficient PE motor operation start signal when the hot gas heat pump device is operated in the hot gas mode. The system further includes a PE heat source generator configured to generate the PE heat source by driving a driving motor in an inefficient mode based on the PE motor operation start signal received from the air conditioning control unit.

The hot gas heat pump device may include the condenser configured to release heat by condensing the high-temperature and high-pressure gaseous refrigerant that passed through the compressor and converting the high-temperature and high-pressure gaseous refrigerant into a high-temperature and high-pressure liquid refrigerant. The hot gas heat pump device may further include an expansion valve configured to generate a low-temperature and low-pressure two-phase refrigerant by expanding the high-temperature and high-pressure liquid refrigerant supplied from the condenser. The hot gas heat pump device may further include an evaporator configured to convert the low-temperature and low-pressure two-phase refrigerant into a low-temperature and low-pressure gaseous refrigerant by absorbing heat from the exterior heat source. The hot gas heat pump device may further include the compressor configured to generate the high-temperature and high-pressure gaseous refrigerant by compressing the low-temperature and low-pressure gaseous refrigerant supplied from the evaporator. The compressor is further configured to provide the generated high-temperature and high-pressure gaseous refrigerant to the condenser. The hot gas heat pump device may further include the hot gas bypass valve configured to open and close the path through which the high-temperature and high-pressure gaseous refrigerant branched and supplied from the compressor re-enters the compressor, based on the control of the air conditioning control unit. The hot gas heat pump device may further include an accumulator disposed between the evaporator and the compressor and and configured to prevent the liquid refrigerant from being supplied to the compressor.

In the heat pump mode, the high-temperature and high-pressure gaseous refrigerant discharged from the compressor may be entirely supplied to the condenser in response to the control of the air conditioning control unit. In the hot gas mode, a portion of the high-temperature and high-pressure gaseous refrigerant discharged from the compressor may be branched and converted into a medium-temperature gaseous refrigerant through the hot gas bypass valve and supplied to the compressor by passing through the accumulator.

In the hot gas mode, the accumulator may convert the low-temperature and low-pressure two-phase refrigerant into the low-temperature and low-pressure gaseous refrigerant by enabling the low-temperature and low-pressure two-phase refrigerant that passes through the evaporator to be mixed and exchange heat with the medium-temperature gaseous refrigerant that passes through the hot gas bypass valve.

Heat released from the condenser may be used for automobile heating or battery heating.

The PE heat source generator may use a motor driving system selectively operated in a single inverter mode or a dual inverter mode.

The PE heat source generator may include a first battery and an open-end winding driving motor in which both ends of three phases are open. The PE heat source generator may further include a first inverter connected to one side of a winding of the driving motor and configured to output a plurality of alternating current power having different phases to the driving motor by converting direct current power of the first battery. The PE heat source generator may further include a second inverter connected to the other side of the winding of the driving motor and configured to output the plurality of alternating current power having different phases to the driving motor by converting the direct current power of the first battery. The PE heat source generator may further include a switching unit configured to switch the connection between the driving motor and the second inverter based on an automobile drive mode. The PE heat source generator may further include a motor control unit configured to control switching of the first inverter, the second inverter, and the switching unit based on switching logic.

In the heat pump mode, the motor control unit may operate the motor driving system in the single inverter mode by controlling the switching unit to disconnect the driving motor from the second inverter when the automotive drive mode is a low output mode. The motor control unit may operate the motor driving system in the dual inverter mode by controlling the switching unit to connect the driving motor with the second inverter when the automobile drive mode is a high output mode.

The motor control unit may control the PE heat source to be generated by controlling the switching unit to connect the driving motor with the second inverter to drive the driving motor in the inefficient mode in the dual inverter mode when the automobile drive mode is the low output mode, based on the PE motor operation start signal received from the air conditioning control unit.

According to an embodiment, a controlling method of an automotive hot gas heat pump system includes checking, by an air conditioning control unit, a heat absorption amount level based on a temperature of an exterior heat source acquired by a sensor unit. The controlling method further includes determining, by the air conditioning control unit, whether to enter a hot gas mode based on a heat absorption amount level and a required heating load. The controlling method further includes transmitting an inefficient power electronics (PE) motor operation start signal to a PE heat source generator based on a determination, by the air conditioning control unit, that the hot gas mode is entered. The controlling method further includes determining, by the air conditioning control unit, a required heat absorption amount in the hot gas mode in which the air conditioning control unit is capable of achieving the required heating load. The controlling method further includes determining, by the PE heat source generator, an operating point based on a load stage based on the determined required heat absorption amount.

Determining the operating point includes selecting, by the motor control unit, the operating point for generating the required heat absorption amount based on an output limit value determined based on motor speed and torque in the dual inverter mode.

The method may further include driving the driving motor by controlling the first and second inverters to output the motor speed and torque corresponding to the operating point selected by the motor control unit.

As set forth above, the automotive hot gas heat pump system and the controlling method thereof according to the embodiments may generate the PE heat source through the inefficient control of the motor even when the heat absorption source is insufficient. The automotive hot gas heat pump system and the controlling method thereof may use the generated PE heat source as the heat absorption source in the hot gas mode to heat the automobile or increase the battery temperature.

### BRIEF DESCRIPTION OF THE DRAWINGS

FIG. 1 is a diagram showing a conventional heating system used in an electric automobile.

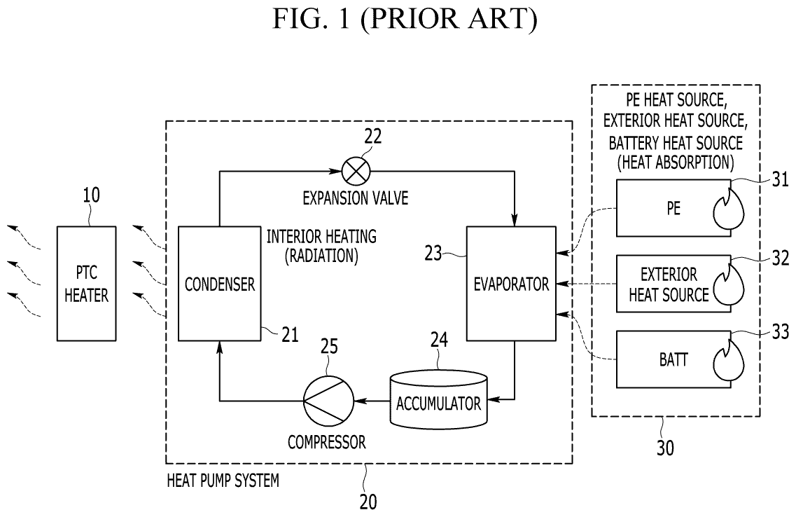

FIG. 2 is a schematic diagram of a conventional battery heating device used in an electric automobile.

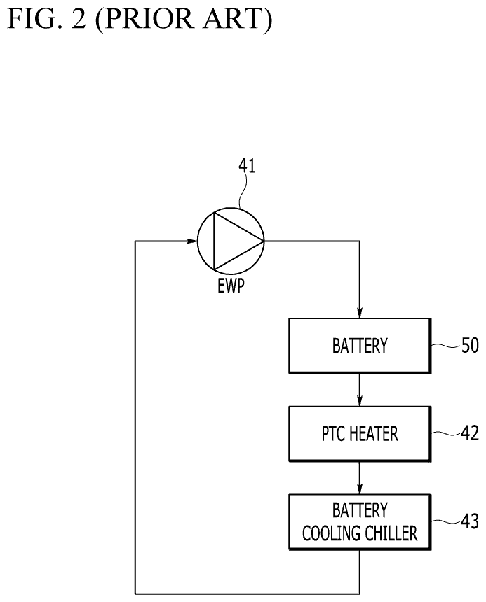

FIG. 3 is a block diagram of an automotive hot gas heat pump system according to an embodiment of the present disclosure.

FIG. 4 is a detailed configuration diagram of a hot gas heat pump device according to an embodiment of the present disclosure.

FIG. 5 is a diagram showing an operation of the hot gas heat pump device of FIG. 4 in a heat pump mode.

FIG. 6 is a diagram showing an operation of the gas heat pump device of FIG. 4 in a hot gas mode.

FIG. 7 is a detailed configuration diagram of a hot gas heat pump device according to another embodiment of the present disclosure.

FIG. 8 is a diagram showing an operation of the hot gas heat pump device of FIG. 7 in the heat pump mode.

FIG. 9 is a diagram showing an operation of the hot gas heat pump device of FIG. 7 in the hot gas mode.

FIG. 10 is a detailed configuration diagram of a power electronics (PE) heat source generator according to an embodiment of the present disclosure.

FIG. 11 is a control flowchart of the PE heat source generator according to an embodiment of the present disclosure.

FIG. 12 is a diagram showing an example of an operating point based on an output limit value determined based on the speed and torque of a motor.

### DETAILED DESCRIPTION

Embodiments of the present disclosure are described in detail with reference to the accompanying drawings so that those having ordinary skill in the art to which the present disclosure pertains may easily practice the present disclosure. However, the present disclosure may be implemented in various different forms and is not limited to the embodiments provided herein. In addition, in the drawings, portions unrelated to the description have been omitted to clearly describe the present disclosure, and similar portions are denoted by similar reference numerals throughout the present disclosure.

Throughout the present disclosure, when any one part “includes” any one component, other components may be included rather than excluded unless explicitly described to the contrary.

In addition, a term “part”, “˜er/or”, “module”, or the like, described in the present disclosure indicates a unit of processing at least one function or operation and may be implemented by hardware, software, or a combination of hardware and software. When a controller, part, ˜er/or, module, component, device, element, or the like of the present disclosure is described as having a purpose or performing an operation, function, or the like, the controller, part, ˜er/or, module, component, device, element, or the like should be considered herein as being “configured to” meet that purpose or to perform that operation or function. Each controller, part, ˜er/or, module, component, device, element, and the like may separately embody or be included with a processor and a memory, such as a non-transitory computer readable media, as part of the apparatus.

The devices described in the present disclosure may include hardware including at least one processor, memory device, communication device, or the like and may store a program executed in combination with the hardware in a designated location. The hardware may have the configuration and capability to perform a method of the present disclosure. The program may include instructions for implementing an operation method of the present disclosure described with reference to the drawings and may execute the present disclosure in combination with the hardware such as the processor and the memory device.

In the present disclosure, “transmission” or “provision” may include not only direct transmission or provision but also indirect transmission or provision through another device or using a bypass path.

In the present, a term of a singular number may be interpreted as the singular number or its plural number unless explicitly expressed otherwise such as “one” or “single”.

Hereinafter, the embodiments of the present disclosure are described in detail with reference to the accompanying drawings. In drawings, the same reference numbers are used to indicate the same or similar components.

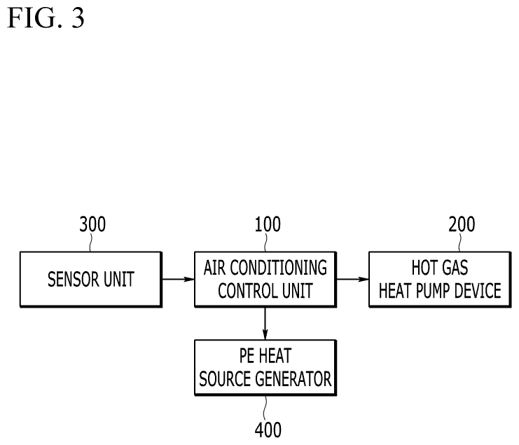

FIG. 3 is a block diagram of an automotive hot gas heat pump system according to an embodiment of the present disclosure.

Referring to FIG. 3, the automotive hot gas heat pump system according to an embodiment of the present disclosure may include an air conditioning control unit 100, a hot gas heat pump device 200, a sensor unit 300, and a power electronics (PE) heat source generator 400.

The sensor unit 300 may measure an automobile exterior temperature, a temperature generated by a PE module (hereinafter, referred to as the “PE temperature”), a temperature generated by a battery (hereinafter, referred to as the “battery temperature”), and an automobile interior temperature.

The air conditioning control unit 100 may control an operation of the hot gas heat pump device 200 based on the exterior temperature, PE temperature, interior temperature, or the like of an automobile, measured by the sensor unit 300. In detail, the air conditioning control unit 100 may control the hot gas heat pump device 200 to be operated in a heat pump mode or a hot gas mode based on the exterior temperature, PE temperature, battery temperature, or interior temperature of the automobile, measured by the sensor unit 300. In addition, the air conditioning control unit 100 may transmit an inefficient PE motor operation start signal to the PE heat source generator 400 when the hot gas heat pump device 200 is operated in the hot gas mode.

The PE heat source generator 400 may generate the PE heat source by driving a driving motor of an electric automobile in an inefficient mode when the PE motor operation start signal is received from the air conditioning control unit 100.

The hot gas heat pump device 200 may be operated in a heat pump mode or the hot gas mode based on control of the air conditioning control unit 100.

According to an embodiment of the present disclosure, the hot gas mode is a technology to overcome a situation where a heat absorption source required for heat pump is insufficient under an extremely low temperature condition or a cold start condition. The hot gas mode is a technology to prevent a compressor suction pressure from falling to a desired setting or less by bypassing a portion of a high-temperature gaseous refrigerant discharged from a compressor to an inlet of the compressor.

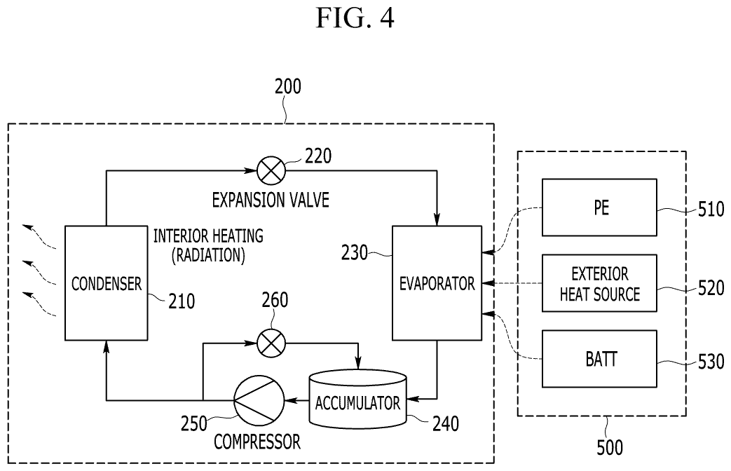

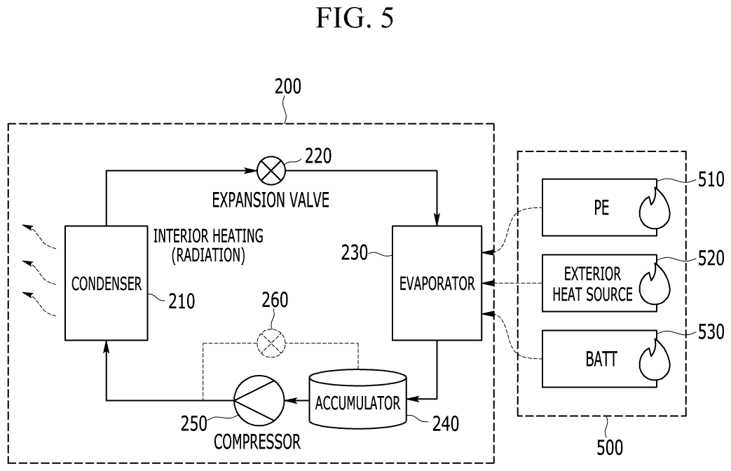

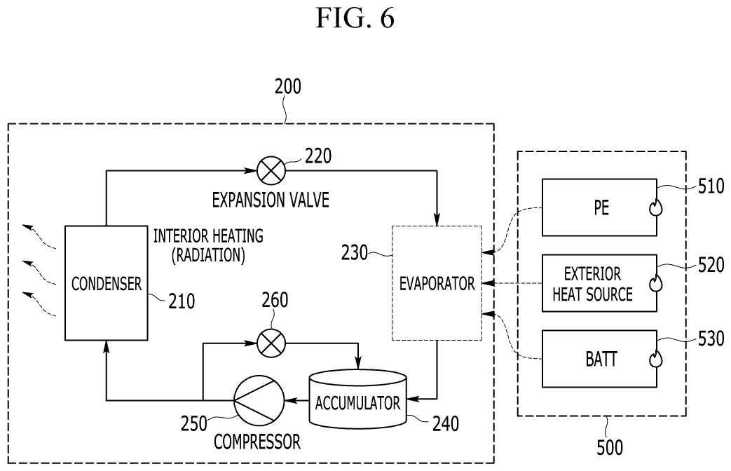

FIG. 4 is a detailed configuration diagram of the hot gas heat pump device 200 according to an embodiment of the present disclosure; FIG. 5 is a diagram showing an operation of the hot gas heat pump device 200 of FIG. 4 in the heat pump mode; and FIG. 6 is a diagram showing an operation of the gas heat pump device 200 of FIG. 4 in the hot gas mode. The hot gas heat pump device according to an embodiment of the present disclosure shown in FIGS. 4, 5, and 6 may be used as a heating device for the electric automobile.

Referring to FIG. 4, the hot gas heat pump device 200 may include a condenser 210, an expansion valve 220, an evaporator 230, an accumulator 240, a compressor 250, and a hot gas bypass valve 260.

The condenser 210 may release heat by condensing a high-temperature and high-pressure gaseous refrigerant that passed through the compressor 250 and may convert the gaseous refrigerant into a high-temperature and high-pressure liquid refrigerant. Heat released from the condenser 210 may be used for automobile heating.

The expansion valve 220 may generate a low-temperature and low-pressure two-phase refrigerant by expanding the high-temperature and high-pressure liquid refrigerant supplied from the condenser 210. Here, the two-phase refrigerant indicates a refrigerant in which its gas and liquid states are mixed with each other.

The evaporator 230 may convert the two-phase refrigerant into the low-temperature and low-pressure gaseous refrigerant by absorbing heat from an exterior heat source 500. In an embodiment of the present disclosure, the exterior heat source 500 may include a PE heat source 510, an exterior heat source 520, and a battery heat source 530 (BATT).

The compressor 250 may discharge the high-temperature and high-pressure gaseous refrigerant by compressing the gaseous refrigerant supplied from the evaporator 230 and may transmit the discharged gaseous refrigerant to the condenser 210. Here, the high-temperature and high-pressure gaseous refrigerant discharged from the compressor 250 may be either entirely supplied to the condenser 210 or partially branched and directed to a bypass path that connects a downstream side of the compressor to the accumulator based on a heating mode (first heating mode or second heating mode) under control of the air conditioning control unit 100. The hot gas bypass valve 260 is disposed on the bypass path and configured to selectively open and close the bypass path.

In other words, the hot gas bypass valve 260 may open or close the bypass path through which the high-temperature and high-pressure gaseous refrigerant, branched from the compressor 250, is supplied back to the compressor 250 under the control of the air conditioning control unit 100. In detail, as shown in FIG. 5, the hot gas bypass valve 260 may block the path through which the high-temperature and high-pressure gaseous refrigerant branched and supplied from the compressor 250 re-enters the compressor 250 in the heat pump mode (first heating mode). In addition, as shown in FIG. 6, the hot gas bypass valve 260 may convert the high-temperature and high-pressure gaseous refrigerant branched and supplied from the compressor 250 into a medium-temperature gaseous refrigerant in the hot gas mode (second heating mode). Thus, the refrigerant may enter the compressor 250 by passing through the accumulator 240. FIGS. 4 and 6 show that the medium-temperature gaseous refrigerant that passed through the hot gas bypass valve 260 directly enters the accumulator 240. However, the present disclosure is not limited thereto, and the refrigerant may be supplied to a refrigerant pipe adjacent to an inlet of the evaporator 230 or an outlet of the evaporator 230 and then may enter the compressor 250 by passing through the accumulator 240.

The accumulator 240 may function to prevent the liquid refrigerant from being supplied to the compressor. In addition, as shown in FIG. 6, in the hot gas mode (second heating mode), the accumulator 240 may convert the two-phase refrigerant into the gaseous refrigerant by enabling the mixing and heat exchange between the low-temperature and low-pressure two-phase refrigerant that passed through the evaporator 230 and the medium-temperature gaseous refrigerant that passed through the hot gas bypass valve 260. Thus, response to a heating load is enabled while the heat absorption amount is insufficient. Here, if the heat absorption amount is excessively high or low, an opening amount of the hot gas bypass valve 260 may be required to be controlled so that the medium-temperature gaseous refrigerant supplied to the accumulator 240 by passing through the hot gas bypass valve 260 is increased. However, as the opening amount of the hot gas bypass valve 260 is increased, the high-temperature and high-pressure gaseous refrigerant supplied from the compressor 250 to the condenser 210 may be reduced. This may result in significantly lower efficiency of a heating system.

Therefore, in an embodiment of the present disclosure, in the hot gas mode (second heating mode), the PE heat source generator 400 may drive the driving motor of the electric automobile in the inefficient mode to generate the PE heat source, and thus the heat absorption amount that is excessively high or low is prevented. In other words, according to an embodiment of the present disclosure, in order to efficiently operate the hot gas mode while a waste heat source is insufficient, the PE heat source may be generated through inefficient control of the driving motor, and enthalpy of the two-phase refrigerant passing through the evaporator 230 by the generated PE heat source may be increased. Thus, the energy efficiency of the heating system may be increased.

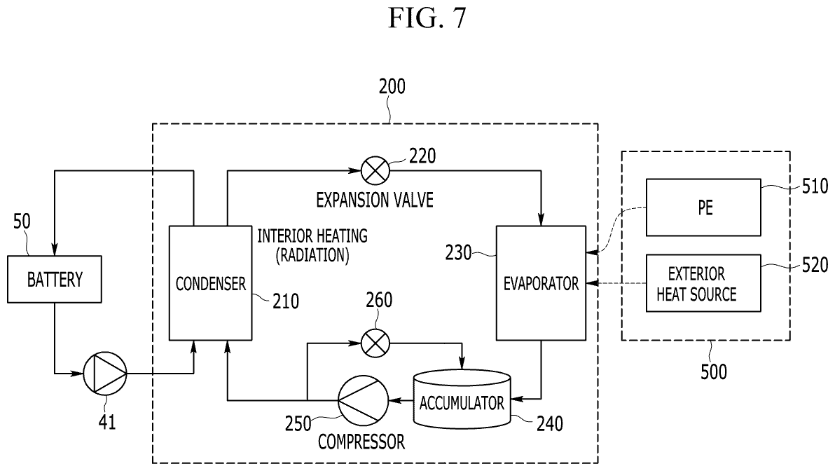

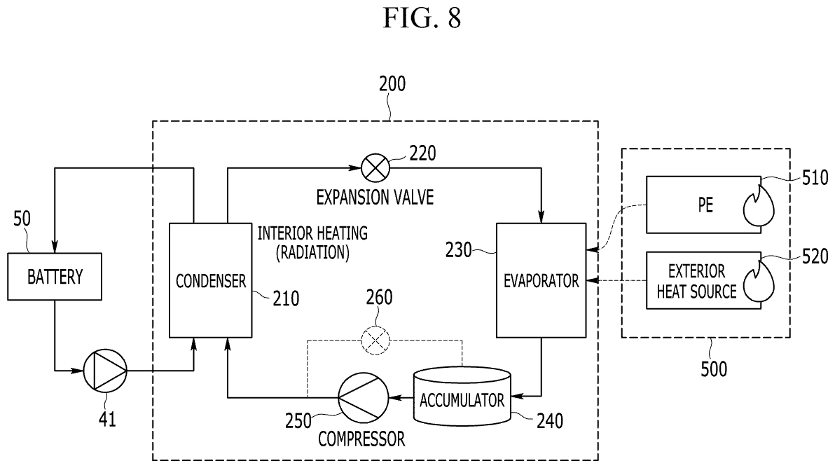

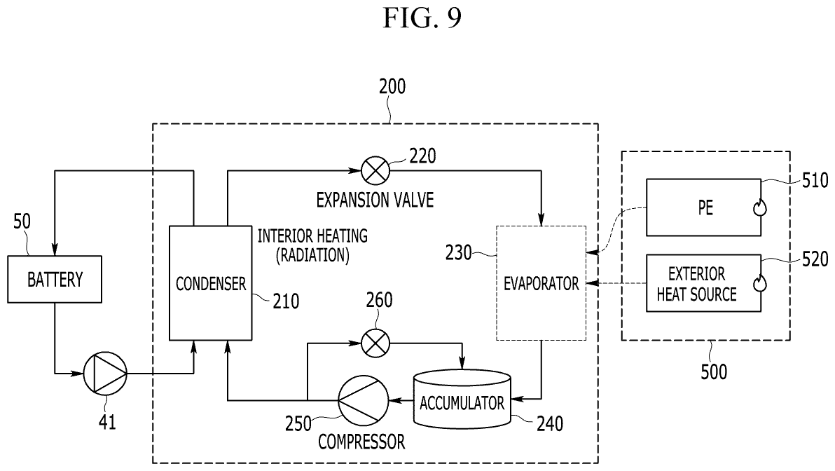

FIG. 7 is a detailed configuration diagram of a hot gas heat pump device 200 according to another embodiment of the present disclosure; FIG. 8 is a diagram showing an operation of the hot gas heat pump device 200 of FIG. 7 in the heat pump mode; and FIG. 9 is a diagram showing an operation of the hot gas heat pump device 200 of FIG. 7 in the hot gas mode. The hot gas heat pump device according to another embodiment of the present disclosure shown in FIGS. 7, 8, and 9 may be used as a battery heating device.

Referring to FIG. 7, the hot gas heat pump device 200 used as the battery heating device may include the condenser 210, the expansion valve 220, the evaporator 230, the accumulator 240, the compressor 250, and a bypass valve 260. FIG. 7 shows a part that performs the same function as the component described with reference to FIG. 4, denoted by the same reference number as in FIG. 4, and its redundant description is thus omitted herein.

The compressor 250 may compress the gaseous refrigerant supplied from the evaporator 230 to discharge the high-temperature and high-pressure gaseous refrigerant and may transmit the discharged gaseous refrigerant to the condenser 210. Here, the high-temperature and high-pressure gaseous refrigerant discharged from the compressor 250 may be supplied entirely to the condenser 210 or partially branched and supplied to the bypass valve 260 based on a battery heating mode (first battery heating mode or second battery heating mode) under the control of the air conditioning control unit 100.

The bypass valve 260 may control a flow of the high-temperature and high-pressure gaseous refrigerant, branched and supplied from the compressor 250, under the control of the air conditioning control unit 100. In detail, as shown in FIG. 8, in the heat pump mode (first battery heating mode), the bypass valve 260 may block the path through which the high-temperature and high-pressure gaseous refrigerant branched and supplied from the compressor 250 re-enters the compressor 250. In addition, as shown in FIG. 8, in the hot gas mode (second battery heating mode), the bypass valve 260 may convert the high-temperature and high-pressure gaseous refrigerant branched and supplied from the compressor 250 into the medium-temperature gaseous refrigerant. Thus, the refrigerant may enter the compressor 250 by passing through the accumulator 240.

The condenser 210 may release heat by condensing the high-temperature and high-pressure gaseous refrigerant that passed through the compressor 250 and may convert the gaseous refrigerant into the high-temperature and high-pressure liquid refrigerant. Heat released from the condenser 210 may be used to heat the battery 50 directly or heat the battery 50 by circulating the coolant flowing in a battery heating pipe supplied to the battery 50 by driving an electronic water pump 41 (also referred to as the “EWP”).

According to an embodiment of the present disclosure, the air conditioning control unit 100 may perform both battery heating and automobile heating simultaneously in the heat pump mode (first battery heating mode). In this case, the coolant heated by the condenser 210 may be supplied for the battery heating and the automobile heating through a battery heating pipe and an automobile interior heating pipe respectively.

According to another embodiment of the present disclosure, the air conditioning control unit 100 may perform only the battery heating without performing the automobile heating in the hot gas mode (second battery heating mode). In this case, the coolant heated by the condenser 210 may be supplied to the battery 50 only through the battery heating pipe, and the coolant supplied to the automobile interior heating pipe may be blocked by a valve. In addition, according to another embodiment of the present disclosure, in order to efficiently operate the hot gas mode (second battery heating mode) while waste heat source is insufficient, the heat source may be secured through the inefficient control of the driving motor, and the enthalpy of the two-phase refrigerant passing through the heat source from the evaporator 230 may be increased. Thus, the energy efficiency of the battery heating system may be increased.

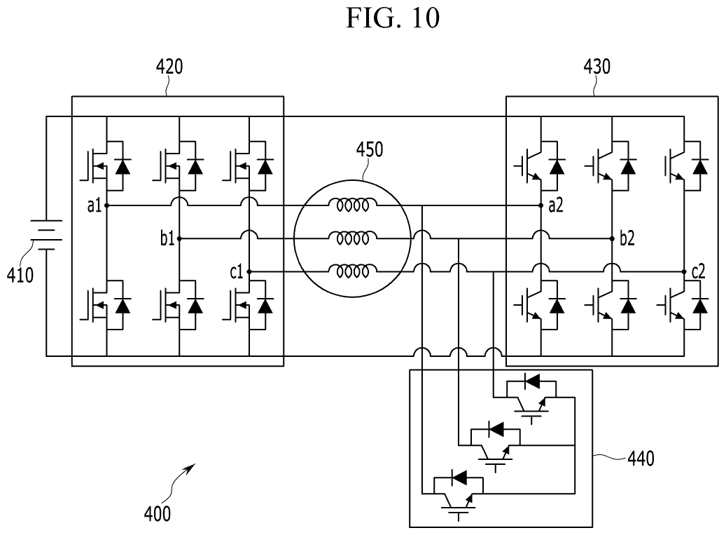

FIG. 10 is a detailed configuration diagram of the PE heat source generator 400 according to an embodiment of the present disclosure.

Referring to FIG. 10, the PE heat source generator 400 according to an embodiment of the present disclosure may use an existing motor driving system driven by two stages, and include a battery 410, a first inverter 420, a second inverter 430, a switching unit 440, a driving motor 450, and a motor control unit.

According to an embodiment of the present disclosure, the PE heat source generator 400 may be configured as a circuit capable of being driven in the two stages based on an automotive drive mode (high output mode or low output mode) as well as a hot gas heating mode. As an example, if the automotive drive mode is the high output mode, the PE heat source generator 400 (using the motor driving system) may be driven in a state where one motor 450 and two inverters 420 and 430 are connected to each other (i.e., open end winding (OEW) state). As another example, if the automotive drive mode is a fuel efficiency mode, the motor driving system 400 may be driven in a state where one driving motor 30 and one inverter 420 are connected to each other (i.e., close end winding (CEW) state, which is also referred to as the “single inverter mode” hereinafter). In addition, in the hot gas heating mode, the PE heat source generator 400 (using the motor driving system) according to an embodiment of the present disclosure may generate the PE heat source by intentionally driving the driving motor in an inefficient high output mode in a state where one motor 450 and the two inverters 420 and 430 are connected to each other (i.e., open end winding (OEW) state, which is also referred to as the “dual inverter mode” hereinafter) even when the automotive drive mode is the fuel efficiency mode.

Referring to FIG. 10, the battery 410 may be an energy storage device for supplying power for driving an electric motor in an eco-friendly automobile including the driving motor 450. The battery 410 applied to the eco-friendly automobile may be discharged when driving the driving motor 450 and may be charged by receiving power from an external system.

The driving motor 450 may be an open-end winding motor (OEW motor) in which both ends of three phases are open, rather than the three phases being connected to a neutral point, and a first inverter 420 is connected to one end of a winding, and the second inverter 430 is connected to the other end of the winding. The driving motor 450 may be supplied with and driven by three-phase alternating current (AC) power converted by the first and second inverters 420 and 430.

The first and second inverters 420 and 430 may be bidirectional inverters selectively operated to output a plurality of AC power having different phases by converting direct current (DC) power of the battery 50, or to output power to the battery 410 by converting plurality of AC powers. In other words, the driving motor 450 may be driven or regenerated by an operation of turning on/off six switching elements included in the first and second inverters 420 and 430, respectively.

The first inverter 420 may have a power input terminal connected to the battery 410 and a first input/output terminals a1, b1, and c1 connected to the driving motor 450. When the driving motor 450 is driven, the first inverter 420 may receive power from the battery 410 at the power input terminal and may convert the same into AC power having the plurality of phases by using the switching elements and may output the same to a plurality of second input/output terminals a2, b2, and c2.

The second inverter 430 may have the second input/output terminals a2, b2, and c2 connected to the driving motor 450. The second inverter 430 may control reactive power of the driving motor 450. In other words, a constant output section based on a voltage limit in a high-speed operation (automotive high output mode) of the first inverter 420 may be expanded by compensating for a reactive power component required for the first inverter 420 using the second inverter 430.

The switching unit 440 may be connected to the second input/output terminals a2, b2, and c2 to which the second inverter 430 and the driving motor 450 are connected. The switching unit 440 may operate the motor driving system 400 in the single inverter mode or the dual inverter mode by switching a connection between the driving motor 450 and the second inverter 430 based on the automotive drive mode.

In detail, the switching unit 440 may operate the motor driving system 400 in the dual inverter mode by connecting the driving motor 450 with the second inverter 430 if the automotive drive mode is the high output mode (high-speed mode) or a hot gas operation mode. The switching unit 440 may operate the motor driving system 400 in the single inverter mode without connecting the driving motor 450 and the second inverter 430 if the automotive drive mode is the low output mode (fuel efficiency mode).

In this way, in the hot gas heating mode, the PE heat source generator 400 according to an embodiment of the present disclosure may generate the PE heat source necessary for the operation in the hot gas mode by intentionally driving the driving motor in the inefficient high output mode in the state where one motor 450 and the two inverters 420 and 430 are connected to each other (i.e., open end winding (OEW) state) even when the automotive drive mode is the fuel efficiency mode.

The motor control unit may drive the motor driving system based on switching logic. In other words, the motor control unit may operate the motor driving system 400 in the single inverter mode by controlling the switching unit 440 to disconnect the driving motor 450 from the second inverter 430 when the automotive drive mode is the low output mode (fuel efficiency mode). The motor control unit may operate the motor driving system 400 in the dual inverter mode by controlling the switching unit 440 to connect the driving motor 450 with the second inverter 430 when the automotive drive mode is the high output mode or the hot gas mode. Here, the motor control unit (MCU) may control conversion of the single inverter mode or the dual inverter mode based on the torque, revolutions per minute (RPM), battery voltage, accelerator pedal pressing degree, battery state of charge (SoC) of the motor system.

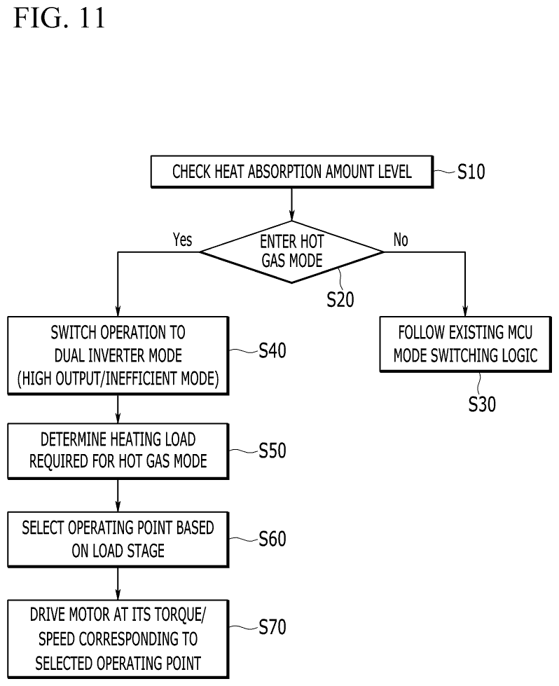

FIG. 11 is a control flowchart of the PE heat source generator 400 according to an embodiment of the present disclosure.

A heat absorption amount level may be checked by the air conditioning control unit 100 based on the exterior temperature, PE temperature, battery temperature, or the like of the automobile, measured by the sensor unit 300 (S10). Whether to enter the hot gas mode may be determined based on the heat absorption amount level and a required heating load (S20). Here, the required heating load may be determined based on the automobile interior temperature, the automobile exterior temperature, and a customer's heating set value.

The motor driving system may be driven by the air conditioning control unit 100 based on switching logic of the motor control unit (MCU) (S30) if it is determined by the air conditioning control unit 100 that the heating load is satisfied in the heat pump mode (first heating mode) as a determination result (No in the step S20). In other words, the motor driving system 400 may be operated in the single inverter mode by the motor control unit, by controlling the switching unit 440 to disconnect the driving motor 450 from the second inverter 430 when the automotive drive mode is the low output mode (fuel efficiency mode). The motor driving system 400 may be operated in the dual inverter mode by controlling the switching unit 440 to connect the driving motor 450 with the second inverter 430 when the automotive drive mode is the high output mode (high-speed mode).

The inefficient PE motor operation start signal may be transmitted to the motor control unit of the PE heat source generator 400 by the air conditioning control unit 100, and the operation may be switched to the dual inverter mode by the motor control unit of the PE heat source generator 400 (S40) if it is determined, by the air conditioning control unit 100, to enter the hot gas mode (second heating mode) as the determination result (Yes in the step S20).

The required heat absorption amount in the hot gas mode may be determined by the air conditioning control unit 100, in which the air conditioning control unit 100 is capable of achieving the required heating load (S50). Here, the required heat absorption amount in the hot gas mode may be determined based on the heat absorption amount level based on the exterior temperature, PE temperature, battery temperature, or the like of the automobile and the required heating load based on the automobile interior temperature, the automobile exterior temperature, and the customer's heating set value.

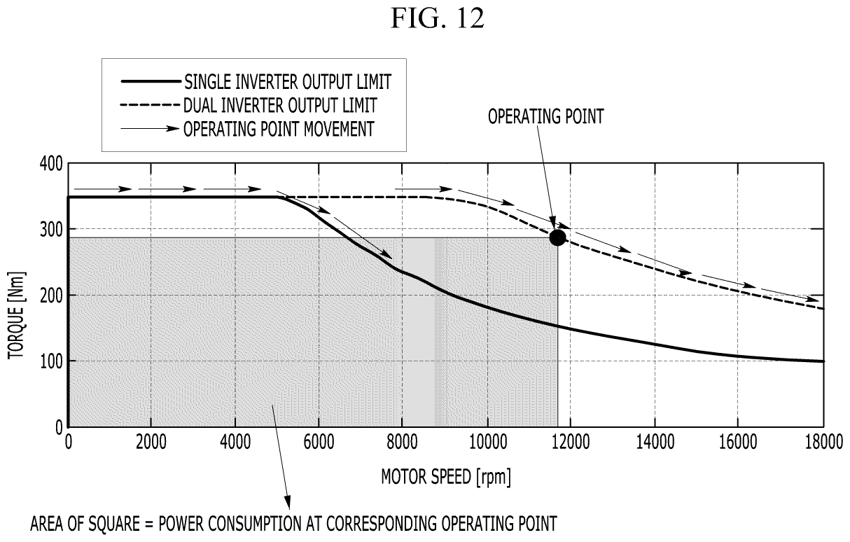

An operating point may be selected based on a load stage by the motor control unit of the PE heat source generator 400 (S60) if the required heat absorption amount is determined in the step S50. In detail, referring to FIG. 12, the operating point for generating the required heat absorption amount may be selected based on the output limit value determined based on motor speed and torque in the dual inverter mode by the motor control unit. FIG. 12 shows that an area of a square on a motor speed axis and a torque axis, determined by the operating point indicates power consumption at the corresponding operating point, and the operating point in the dual inverter mode may thus be selected based on the determined required heat absorption amount.

The motor may be driven by the motor control unit, by controlling the inverter to output the selected motor speed and torque (S70) when the motor speed and torque corresponding to the selected operating point is acquired by the motor control unit of the PE heat source generator 400.

The steps may be performed in an appropriate order unless there is an explicit order or description to the contrary regarding the steps configuring the method according to this embodiment. The present disclosure is not necessarily limited to the order of the steps described above. Any use of examples or terms in the present disclosure is intended merely to describe the present disclosure in more detail and does not limit the scope of the present disclosure. In addition, those having ordinary skill in the art should appreciate that various modifications, combinations, and changes may be made within the scope of the patent claims or their equivalents.

Although the embodiments of the present disclosure have been described in detail hereinabove, the scope of the present disclosure is not limited thereto. Various modifications and improvements made by those having ordinary skill in the art to which the present disclosure pertains also fall into the scope of the present disclosure.

### DESCRIPTION OF SYMBOLS

10 PTC electric heater, 20 heat pump system, 21 condenser, 22 expansion valve, 23 evaporator, 24 accumulator, 25 compressor, 30 heat source, 31 PE heat source, 32 exterior heat source, 33 battery heat source, 41 electronic water pump, 42 PTC electric heater, 43 battery cooling chiller, 50 battery, 100 air conditioning control unit, 200 hot gas heat pump device, 300 sensor unit, 400 PE heat source generator, 210 condenser, 220 expansion valve, 230 evaporator, 240 accumulator, 250 compressor, 260 hot gas bypass valve, 500 heat source, 510 PE heat source, 520 exterior heat source, 530 battery heat source

What is claimed is:

1. An automotive hot gas heat pump system comprising:
a sensor unit configured to measure a temperature of at least one of exterior heat source, power electronics (PE) heat source, or battery heat source of an automobile;
a hot gas heat pump device, including:
a compressor;
a condenser configured to release heat by condensing a high-temperature and high-pressure gaseous refrigerant supplied from the compressor; and
a hot gas bypass valve configured to open and close a path through which the high-temperature and high-pressure gaseous refrigerant, branched from the compressor, re-enters the compressor, the hot gas bypass valve configured to be operated in a heat pump mode or a hot gas mode based on opening or closing operation of the hot gas bypass valve;
an air conditioning control unit configured to:
control the hot gas heat pump device to be operated in the heat pump mode or the hot gas mode based on a heat absorption amount, the heat absorption amount determined based on the temperature measured by the sensor unit and a required heating load; and
generate an inefficient PE motor operation start signal when the hot gas heat pump device is operated in the hot gas mode; and
a PE heat source generator configured to generate the PE heat source by driving a driving motor in an inefficient mode based on the PE motor operation start signal received from the air conditioning control unit.

2. The system of claim 1, wherein the hot gas heat pump device includes:
the condenser configured to release heat by condensing the high-temperature and high-pressure gaseous refrigerant that passed through the compressor and converting the high-temperature and high-pressure gaseous refrigerant into a high-temperature and high-pressure liquid refrigerant;
an expansion valve configured to generate a low-temperature and low-pressure two-phase refrigerant by expanding the high-temperature and high-pressure liquid refrigerant supplied from the condenser;
an evaporator configured to convert the low-temperature and low-pressure two-phase refrigerant into a low-temperature and low-pressure gaseous refrigerant by absorbing heat from the exterior heat source;
the compressor configured to:
generate the high-temperature and high-pressure gaseous refrigerant by compressing the low-temperature and low-pressure gaseous refrigerant supplied from the evaporator; and
provide the generated high-temperature and high-pressure gaseous refrigerant to the condenser;
the hot gas bypass valve configured to open and close the path based on the control of the air conditioning control unit; and
an accumulator disposed between the evaporator and the compressor and configured to prevent the high-temperature and high-pressure liquid refrigerant from being supplied to the compressor.

3. The system of claim 2, wherein in the heat pump mode, the high-temperature and high-pressure gaseous refrigerant discharged from the compressor is entirely supplied to the condenser in response to the control of the air conditioning control unit, and
wherein, in the hot gas mode, a portion of the high-temperature and high-pressure gaseous refrigerant supplied from the compressor through the path is converted into a medium-temperature gaseous refrigerant through the hot gas bypass valve and supplied to the compressor by passing through the accumulator.

4. The system of claim 3, wherein in the hot gas mode, the accumulator is configured to convert the low-temperature and low-pressure two-phase refrigerant into the low-temperature and low-pressure gaseous refrigerant by enabling the low-temperature and low-pressure two-phase refrigerant that passes through the evaporator to be mixed and exchange heat with the medium-temperature gaseous refrigerant that passes through the hot gas bypass valve.

5. The system of claim 4, wherein heat released from the condenser is used to heat an interior of the automobile.

6. The system of claim 5, wherein heat released from the condenser is used to heat a battery of the automobile.

7. The system of claim 1, wherein the PE heat source generator is configured to use a motor driving system selectively operated in a single inverter mode or a dual inverter mode.

8. The system of claim 7, wherein the PE heat source generator includes:
a first battery;
an open-end winding driving motor in which both ends of three phases are open;
a first inverter connected to one side of a winding of the driving motor and configured to output a plurality of alternating current power having different phases to the driving motor by converting direct current power of the first battery;
a second inverter connected to the other side of the winding of the driving motor and configured to output the plurality of alternating current power having different phases to the driving motor by converting the direct current power of the first battery,
a switching unit configured to switch a connection between the driving motor and the second inverter based on an automobile drive mode; and
a motor control unit configured to control switching of the first inverter, the second inverter, and the switching unit based on switching logic.

9. The system of claim 8, wherein in the heat pump mode, the motor control unit is configured to:
operate the motor driving system in the single inverter mode by controlling the switching unit to disconnect the driving motor from the second inverter when an automotive drive mode is a low output mode; and
operate the motor driving system in the dual inverter mode by controlling the switching unit to connect the driving motor with the second inverter when the automobile drive mode is a high output mode.

10. The system of claim 9, wherein the motor control unit is configured to control the PE heat source to be generated by controlling the switching unit to connect the driving motor with the second inverter to drive the driving motor in the inefficient mode in the dual inverter mode when the automobile drive mode is the low output mode, based on the PE motor operation start signal received from the air conditioning control unit.

11. A controlling method of an automotive hot gas heat pump system, the method comprising:
checking, by an air conditioning control unit, a heat absorption amount level based on a temperature of an exterior heat source acquired by a sensor unit;
determining, by the air conditioning control unit, whether to enter a hot gas mode based on a heat absorption amount level and a required heating load;
transmitting an inefficient power electronics (PE) motor operation start signal to a PE heat source generator based on a determination, by the air conditioning control unit, that the hot gas mode is entered;
determining, by the air conditioning control unit, a required heat absorption amount in the hot gas mode in which the air conditioning control unit is capable of achieving the required heating load; and
determining, by the PE heat source generator, an operating point based on a load stage based on the determined required heat absorption amount.

12. The method of claim 11, further comprising:
outputting, by a first inverter, a plurality of alternating current power having different phases to an driving motor by converting direct current power of a first battery,
outputting, by a second inverter, the plurality of alternating current power having different phases to the driving motor by converting the direct current power of the first battery;
switching, by a switching unit, a connection between the driving motor and the second inverter based on an automobile drive mode; and
controlling, a motor control unit, switching of the first inverter, the second inverter, and the switching unit based on switching logic.

13. The method of claim 12, further comprising:
generating the PE heat source under a control of the motor control unit by controlling the switching unit to connect the driving motor with the second inverter to drive the driving motor in an inefficient mode in a dual inverter mode, bases on the PE motor operation start signal received from the air conditioning control unit.

14. The method of claim 13, wherein determining the operating point comprises:
selecting, by the motor control unit, the operating point for generating the required heat absorption amount based on an output limit value determined based on motor speed and torque in the dual inverter mode.

15. The method of claim 14, further comprising:
driving the driving motor by controlling the first and second inverters to output motor speed and torque corresponding to the operating point selected by the motor control unit.
